(19) United States
(12) Patent Application Publication
(10) Pub. No.: US 2026/0155426 A1
(43) Pub. Date: Jun. 4, 2026

(54) RESTRAINT DEVICE

(71) Applicant: TOYOTA JIDOSHA KABUSHIKI KAISHA, Toyota-shi (JP)

(72) Inventors: Masashi YAMAKITA, Nagoya-shi (JP); Akinori SAITO, Kariya-shi (JP); Yushi KONDO, Kariya-shi (JP); Yusuke YAMASHITA, Kariya-shi (JP)

(73) Assignee: TOYOTA JIDOSHA KABUSHIKI KAISHA, Toyota-shi (JP)

(21) Appl. No.: 19/357,528

(22) Filed: Oct. 14, 2025

(30) Foreign Application Priority Data
Nov. 29, 2024 (JP) 2024-208723

(51) Int. Cl. H01M 10/04; H01M 4/70; H01M 10/0585; H01M 50/30; H01M 50/474

(52) U.S. Cl. CPC H01M 10/0468; H01M 4/70; H01M 10/0585; H01M 50/394; H01M 50/474

(57) ABSTRACT

A restraint device includes an elastic member that is stacked with a power storage module in a Z direction, and an end plate that presses the elastic member toward the power storage module. The elastic member includes a first elastic portion and a second elastic portion that is softer than the first elastic portion. The first elastic portion is provided at a position that does not overlap a gas channel in the Z direction, and the second elastic portion is provided at a position that overlaps the gas channel in the Z direction.

### CROSS-REFERENCE TO RELATED APPLICATION

This application claims priority to Japanese Patent Application No. 2024-208723 filed on Nov. 29, 2024. The disclosure of the above-identified application, including the specification, drawings, and claims, is incorporated by reference herein in its entirety.

### BACKGROUND

### 1. Technical Field

The present disclosure relates to a restraint device.

### 2. Description of Related Art

Japanese Unexamined Patent Application Publication No. 2018-098211 (JP 2018-098211 A) discloses a secondary battery in which a plurality of unit cell layers are stacked. Secondary battery electrodes that are included in the secondary battery include a current collector, and an electrode layer that is disposed on a surface of the current collector. A gas channel is formed in the electrode layer.

### SUMMARY

Although not described in the aforementioned JP 2018-098211 A, there are cases in which secondary batteries (power storage modules) are restrained in a stacking direction. In this case, it is conceivable that the gas channel might be crushed by a restraint load. There is a concern that as a result of this, gas might accumulate inside the battery, causing deterioration of battery performance.

The present disclosure has been made to solve the above-described problem, and an object thereof is to provide a restraint device that is capable of suppressing a gas channel of an electrode layer from being crushed.

A restraint device according to an aspect of the present disclosure is a restraint device for restraining a power storage module, the restraint device including an elastic member that is stacked with the power storage module in a stacking direction, in a state in which the power storage module is restrained, and a pressing member that presses the elastic member toward the power storage module. The power storage module includes an electrode plate. The electrode plate includes a current collector, and an electrode layer that is stacked with the current collector in the stacking direction. A gas channel is fashioned in the electrode layer. The elastic member includes a first elastic portion, and a second elastic portion that is softer than the first elastic portion. The first elastic portion is provided at a first position not overlapping the gas channel in the stacking direction. The second elastic portion is provided at a second position overlapping the gas channel in the stacking direction.

According to the present disclosure, a gas channel of an electrode layer can be suppressed from being crushed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a configuration of a restraint device and a stack according to an embodiment;

FIG. 2 is a disassembled view of FIG. 1;

FIG. 3 is a cross-sectional view illustrating a configuration of an elastic member and the stack according to the embodiment;

FIG. 4 is a planar cross-sectional view of the elastic member according to the embodiment; and

FIG. 5 is a cross-sectional view illustrating a configuration of a restraint device and a stack according to a modification of the embodiment.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

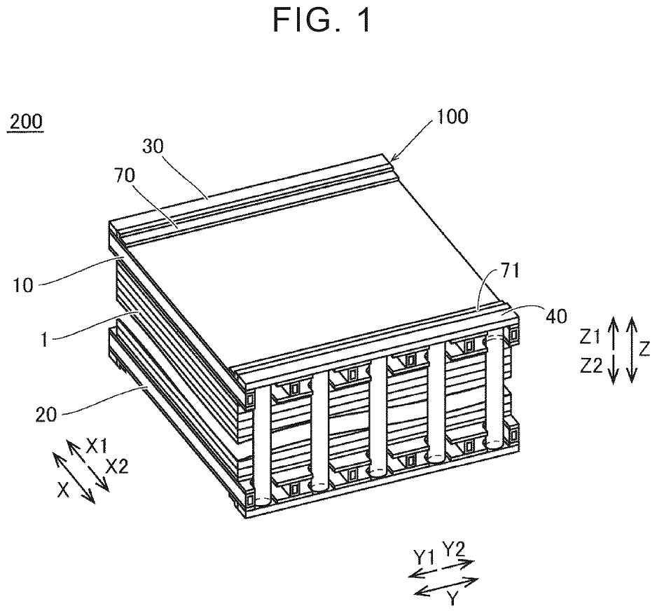

A restraint device 100 according to the embodiment of the present disclosure will be described with reference to FIGS. 1 to 4. The restraint device 100 is a jig that restrains power storage modules during a manufacturing process of a power storage device. Note that the power storage modules may be, for example, secondary batteries such as lithium-ion batteries or the like.

FIG. 1 is a perspective view schematically illustrating a power storage unit 200 that is made up a stack 1 and the restraint device 100. In FIG. 1, the restraint device 100 restrains the stack 1. Note that in the present specification, a Z direction is a stacking direction of the stack 1. Also, an X direction and a Y direction are each directions orthogonal to the Z direction. The X direction and the Y direction are orthogonal to each other in a plane that is orthogonal to the Z direction. Note that the Z direction is an example of the “stacking direction” in the present disclosure.

The restraint device 100 includes end plates 10 and 20, and restraint members 30 and 40. The restraint device 100 applies a restraint load to the stack 1 in the Z direction. Applying an appropriate restraint load to the stack 1 appropriately maintains inter-electrode distances in the power storage modules. As a result, deposition of metal (e.g., lithium) on an electrode (anode) of the power storage module can be suppressed. Note that each of the end plate 10 and the end plate 20 is an example of “pressing member” in the present disclosure.

The stack 1 is sandwiched between the end plate 10 and the end plate 20 in the Z direction. The end plate 10 is disposed on a Z1 side with respect to the stack 1. The end plate 20 is disposed on a Z2 side with respect to the stack 1.

The restraint member 30 restrains an end portion of the stack 1, on an X1 side thereof, in the Z direction. The restraint member 40 restrains an end portion of the stack 1, on an X2 side thereof, in the Z direction.

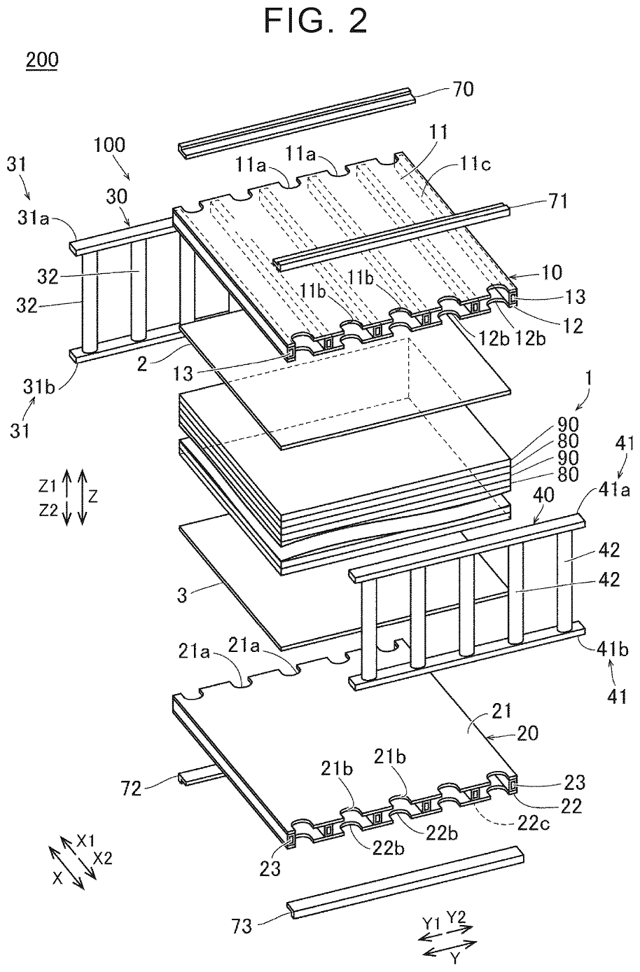

FIG. 2 illustrates a disassembled perspective view of the power storage unit 200. The stack 1 is formed in a cuboid shape, for example. The stack 1 includes at least one power storage module 80, at least one interposition module 90, and elastic sheets 2 and 3. In the present embodiment, the stack 1 includes a plurality of the power storage modules 80 and a plurality of the interposition modules 90. Note that the elastic sheets 2 and 3 are made of urethane, for example. The elastic sheets 2 and 3 have insulating properties.

The power storage modules 80 are arranged in the Z direction. The interposition modules 90 are disposed between the power storage modules 80 that are arrayed in the Z direction. Also, interposition modules 90 are also disposed between the power storage modules 80 and each of the elastic sheet 2 and the elastic sheet 3.

The interposition modules 90 are electrically conductive. Specifically, the interposition modules 90 each include a current collector plate that is omitted from illustration. This current collector plate is electrically connected to a power source that is omitted from illustration, and is supplied with an electric current from the power source. For example, the current collector plate that is included in the interposition module 90 that is closest to the Z1 side among the multiple interposition modules 90 may be electrically connected to one of a positive pole and a negative pole of the power source, and the current collector plate that is included in the interposition module 90 that is closest to the Z2 side among the multiple interposition modules 90 may be electrically connected to the other of the positive pole and the negative pole of the power source. Thus, each of the power storage modules 80 in the stack 1 is charged. Note that the method of charging the power storage modules 80 is not limited to the above example.

The elastic sheet 2 is disposed between the end plate 10 and the stack 1. The elastic sheet 2 is sandwiched between the end plate 10 and the stack 1 in the Z direction. The elastic sheet 3 is disposed between the end plate 20 and the stack 1. The elastic sheet 3 is sandwiched between the end plate 20 and the stack 1 in the Z direction. The elastic sheets 2 and 3 enable a uniform restraint load to be applied to the stack 1.

The end plates 10 and 20 apply pressure to the stack 1 in the Z direction. Specifically, the end plate 10 applies pressure to the stack 1 toward the Z2 side, and the end plate 20 applies pressure to the stack 1 toward the Z1 side. The end plates 10 and 20 are plate-shaped members. The end plate 10 has a rectangular shape covering the stack 1, as viewed in plan view from a position away from the end plate 10 on the Z1 side. The end plate 20 has a rectangular shape covering the stack 1, as viewed in plan view from a position away from the end plate 20 on the Z2 side.

The end plate 10 includes a first plate 11, a second plate 12, and a plurality of ribs 13. The first plate 11 and the second plate 12 are arranged in the Z direction. The first plate 11 and the second plate 12 face each other in the Z direction. Note that the first plate 11 has the same shape and size as those of the second plate 12.

Each of the ribs 13 is provided between the first plate 11 and the second plate 12. The first plate 11 and the second plate 12 are linked by the ribs 13. Each of the ribs 13 extends in the X direction. The ribs 13 are arranged at intervals in the Y direction.

The first plate 11 is formed with a plurality of (five in the present embodiment) notches 11a, and a plurality of (five in the present embodiment) notches 11b. The notches 11a are provided arrayed along a side of the first plate 11 on the X1 side. The notches 11b are provided arrayed along a side of the first plate 11 on the X2 side.

The second plate 12 has a plurality of notches 12b that is formed so as to be provided below the notches 11b of the first plate 11. That is to say, the notches 12b overlap the notches 11b in the Z direction.

Although not illustrated in FIG. 2, the second plate 12 has a plurality of notches that is formed so as to be provided below the notches 11a of the first plate 11. These notches overlap the notches 11a in the Z direction.

The end plate 20 has the same configuration as that of the end plate 10. That is to say, the end plate 20 includes a first plate 21, a second plate 22, and a plurality of ribs 23. The first plate 21 is formed with a plurality of notches 21a and a plurality of notches 21b. The second plate 22 is formed with a plurality of notches 22b and a plurality of notches (omitted from illustration) overlapping the notches 21a in the Z direction.

The restraint members 30 and 40 are arranged at a distance from each other in the X direction, with the stack 1 sandwiched therebetween. Pressure is applied to the stack 1 in the Z direction by being sandwiched between the restraint members 30 and 40. The restraint member 30 is disposed on the X1 side of the stack 1. The restraint member 40 is disposed on the X2 side of the stack 1. The restraint member 30 has the same shape as the restraint member 40. Accordingly, just the configuration of the restraint member 40 will be described in detail below.

The restraint member 40 includes a frame 41 and a plurality of columnar members 42. The frame 41 has an upper frame 41a and a lower frame 41b. The upper frame 41a and the lower frame 41b are arranged across an interval in the Z direction. Each of the upper frame 41a and the lower frame 41b extends in the Y direction.

The columnar members 42 are arranged at intervals in the Y direction, between the upper frame 41a and the lower frame 41b. Each of the columnar members 42 extends in the Z direction and also connects the upper frame 41a and the lower frame 41b.

In a state in which the restraint member 40 is restraining the stack 1, each of the columnar members 42 passes through the notches 11b, 12b, 21b, and 22b that are provided overlapping each other in the Z direction. In this state, a lower face of the upper frame 41a comes into contact with an upper face 11c of the first plate 11. An upper face of the lower frame 41b comes into contact with a lower face 22c of the second plate 22. Accordingly, the stack 1, the end plate 10, and the end plate 20 are sandwiched between the upper frame 41a and the lower frame 41b.

The restraint member 30 includes a frame 31 and a plurality of columnar members 32. The frame 31 has an upper frame 31a and a lower frame 31b.

In a state in which the restraint member 30 is restraining the stack 1, each of the columnar members 32 passes through the notches 11a and 21a that are arranged in the Z direction, and notches that are omitted from illustration, formed in each of the second plate 12 and the second plate 22. In this state, a lower face of the upper frame 31a comes into contact with the upper face 11c of the first plate 11. An upper face of the lower frame 31b comes into contact with the lower face 22c of the second plate 22. Thus, the stack 1, the end plate 10, and the end plate 20 are sandwiched between the upper frame 31a and the lower frame 31b.

The restraint device 100 includes a protective member 70, a protective member 71, a protective member 72, and a protective member 73.

Each of the protective member 70 and the protective member 71 is disposed between the restraint member 30 and the restraint member 40, and is also fixed to the upper face 11c of the first plate 11. The protective member 70 extends in the Y direction along the upper frame 31a. The protective member 71 extends in the Y direction along the upper frame 41a.

Each of the protective member 72 and the protective member 73 is disposed between the restraint member 30 and the restraint member 40, and is also fixed to the lower face 22c of the second plate 22. The protective member 72 extends in the Y direction along the lower frame 31b. The protective member 73 extends in the Y direction along the lower frame 41b.

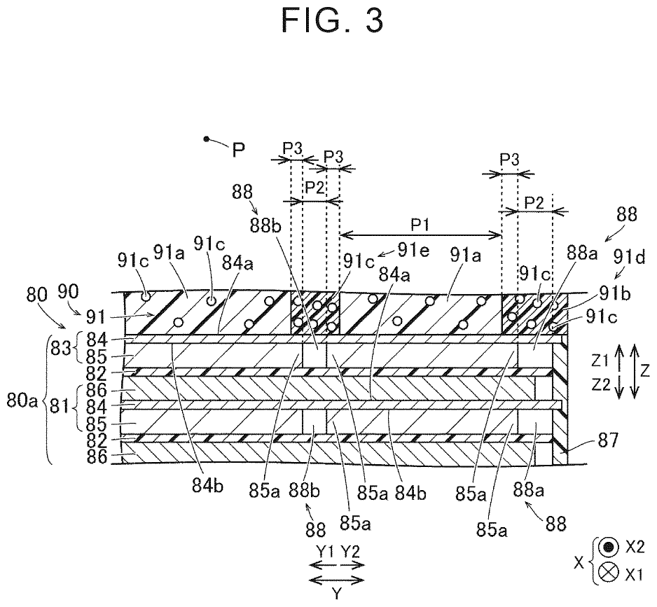

FIG. 3 is a partially enlarged view illustrating a cross-section of the stack 1. The interposition module 90 includes an elastic member 91 for making planar pressure that is applied to the power storage module 80 to be uniform. The elastic member 91 is pressed toward the power storage module 80 by the end plate 10 (20) (FIG. 2). Note that in order to ensure electrical conductivity in the stack 1, a conductive sheet member or the like may be disposed on a surface of the elastic member 91. This electrically connects the current collector (omitted from illustration) that is included in the interposition module 90 to the elastic member 91.

As illustrated in FIG. 3, the power storage module 80 is a bipolar type power storage unit. Note that the power storage module 80 may be a monopolar type power storage unit.

The power storage module 80 includes a plurality of electrode plates 81, a plurality of separators 82, a cathode terminal electrode plate 83, and an anode terminal electrode plate (omitted from illustration). The electrode plates 81, the cathode terminal electrode plate 83, and the anode terminal electrode plate are stacked in the Z direction, with the separators 82 interposed therebetween. The electrode plates 81, the cathode terminal electrode plate 83, the anode terminal electrode plate, and the separators 82, make up a stacked electrode assembly 80a. Note that the electrode plate 81 and the cathode terminal electrode plate 83 are each an example of “electrode plate” of the present disclosure.

Each of the electrode plates 81 is disposed between the cathode terminal electrode plate 83 and the anode terminal electrode plate (omitted from illustration). The electrode plates 81 are bipolar electrodes in the present embodiment. Each of the electrode plates 81 includes a current collector 84, a cathode layer 85, and an anode layer 86. Note that the cathode layer 85 is an example of “electrode layer” of the present disclosure.

In the electrode plate 81, the anode layer 86 is provided on a principal face 84a on the Z1 side of the current collector 84. In the electrode plate 81, the cathode layer 85 is provided on a principal face 84b on the Z2 side of the current collector 84.

The cathode terminal electrode plate 83 is situated at an end portion of the power storage module 80 on the Z1 side. The cathode terminal electrode plate 83 includes the current collector 84 and the cathode layer 85. In the cathode terminal electrode plate 83, the anode layer 86 and the cathode layer 85 are not provided on the principal face 84a of the current collector 84, and the cathode layer 85 is provided on the principal face 84b of the current collector 84. The elastic member 91 is disposed on the principal face 84a of the current collector 84 of the cathode terminal electrode plate 83. Note that the anode terminal electrode plate, which is omitted from illustration, is situated at an end portion of the power storage module 80 on the Z2 side.

Note that the following description of the cathode layer 85 applies to both the cathode layer 85 of the electrode plate 81 and the cathode layer 85 of the cathode terminal electrode plate 83.

The power storage module 80 includes a resin sealant 87. The resin sealant 87 is provided so as to seal the perimeter of the stacked electrode assembly 80a. The resin sealant 87 seals internal space that is formed between two electrode plates 81 that are adjacent to each other. An electrolytic solution is injected into this internal space.

A gas channel 88 is formed in the cathode layer 85. Gas that is generated in the power storage module 80 flows through the gas channel 88. The gas that has flowed through the gas channel 88 is externally discharged from the power storage module 80, from a discharge port, omitted from illustration, that is formed in the resin sealant 87. Note that the gas channel may be formed in the anode layer 86.

The gas channel 88 includes a gas channel 88a and a gas channel 88b. The gas channel 88a and the gas channel 88b communicate with each other. Note that the gas channel 88a and the gas channel 88b are examples of “first gas channel” and “second gas channel” of the present disclosure, respectively.

The gas channel 88a extends along an outer peripheral edge portion of the electrode plate 81 (cathode terminal electrode plate 83). The gas channel 88a is a groove that is formed between the outer peripheral edge portion of the cathode layer 85 and the resin sealant 87. The gas channel 88b is formed on an inner side from the outer peripheral edge portion of the electrode plate 81 (cathode terminal electrode plate 83). The gas channel 88b is a groove that is formed between portions of the cathode layer 85. Note that the gas channels may be formed, for example, from through holes formed in the cathode layer 85 (anode layer 86).

The cathode layer 85 is not provided between the gas channel 88 and the current collector 84. That is to say, the current collector 84 is exposed at a portion at which the gas channel 88 is provided. In the portion at which the gas channel 88 is provided, the current collector 84 and the separator 82 face each other. Note that in the portion at which the gas channel 88 is provided, the current collector 84 does not necessarily have to be exposed, due to a thin film of the cathode layer 85 being provided.

The elastic member 91 includes an elastic portion 91a and an elastic portion 91b. The elastic portion 91b is softer than the elastic portion 91a. Specifically, the elastic portion 91b exhibits a greater deformation amount than the elastic portion 91a, when the same load is applied. In other words, the elastic portion 91b requires a smaller load to be deformed by the same amount, as compared with the elastic portion 91a. The elastic portion 91a and the elastic portion 91b are examples of “first elastic portion” and “second elastic portion” of the present disclosure, respectively.

The elastic portion 91a is made of the same material as that of the elastic portion 91b. Specifically, each of the elastic portion 91a and the elastic portion 91b is made of a foaming urethane resin.

This allows the number of types of parts of the restraint device 100 to be reduced, as compared with when the elastic portion 91a and the elastic portion 91b are made of different materials.

Each of the elastic portion 91a and the elastic portion 91b contains a foaming agent 91c. In the present embodiment, density of the foaming agent 91c in the elastic portion 91b is higher than density of the foaming agent 91c in the elastic portion 91a. This makes the elastic portion 91b to be softer (less rigid) than the elastic portion 91a. For example, the density of the foaming agent 91c in the elastic portion 91b may be twice or more the density of the foaming agent 91c in the elastic portion 91a.

Thus, adjusting the density of the foaming agent 91c for each portion enables a plurality of portions, each having different hardness from each other, to be easily formed in the elastic member 91.

Here, in a conventional restraint device, it is conceivable that the gas channel may be crushed by the restraint load. There is a concern that as a result of this, gas might accumulate inside the battery, causing deterioration of battery performance.

Accordingly, in the present embodiment, the elastic portion 91a is provided at a position P1 that does not overlap the gas channel 88 in the Z direction. The elastic portion 91b is provided at a position P2 overlapping the gas channel 88 in the Z direction. Note that the position P1 and the position P2 are examples of “first position” and “second position” in the present disclosure.

Thus, the elastic portion 91b, which is relatively soft, is disposed at the position P2 overlapping the gas channel 88 in the Z direction, and accordingly pressure that is applied to the gas channel 88 when the power storage module 80 is restrained can be made to be relatively small. As a result, the gas channel 88 can be suppressed from being crushed.

The elastic portion 91b is disposed in a range overlapping the entire range in which the gas channel 88 is provided, in the Z direction.

The elastic portion 91b includes a portion 91d and a portion 91e. Viewing the electrode plate 81 (cathode terminal electrode plate 83) from a position P away from the electrode plate 81 (cathode terminal electrode plate 83) in the Z direction, the portion 91d extends along the gas channel 88a. That is to say, the portion 91d extends along the outer peripheral edge portion of the electrode plate 81 (cathode terminal electrode plate 83). Viewing the electrode plate 81 (cathode terminal electrode plate 83) from the position P, the portion 91e extends along the gas channel 88b. Note that the portion 91d and the portion 91e are examples of “first portion” and “second portion” according to the present disclosure, respectively.

This enables the gas channel 88a and the gas channel 88b to each be suppressed from being crushed by the elastic member 91.

Viewing the electrode plate 81 (cathode terminal electrode plate 83) from the position P, the cathode layer 85 has an adjacent portion 85a that is adjacent to the gas channel 88.

The elastic portion 91b extends from the position P2 to positions P3 at which it overlaps the adjacent portion 85a in the Z direction.

Thus, the elastic portion 91b extends to the positions P3 at which it overlaps the adjacent portion 85a that is adjacent to the gas channel 88 in the Z direction, and accordingly the gas channel 88 can be more reliably suppressed from being crushed.

Specifically, the portion 91d of the elastic portion 91b extends from the position P2 to the position P3 on the opposite side from an outer peripheral edge portion of the elastic member 91 (Y1 side in FIG. 3). Furthermore, the portions 91e of the elastic portion 91b extend to the positions P3 that are provided on both ends (Y1 side and Y2 side) of the position P2.

Note that the width of the position P2 in the Y direction may be larger than the width of the position P3 in the Y direction.

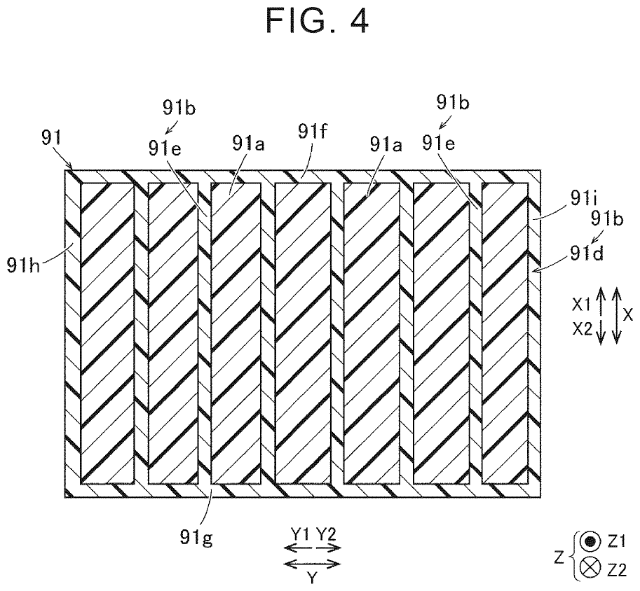

FIG. 4 illustrates a planar cross-section of the elastic member 91. As illustrated in FIG. 4, the portion 91d of the elastic portion 91b is formed in an annular shape. Specifically, the portion 91d includes a side 91f and a side 91g that are arranged in the X direction. Each of the side 91f and the side 91g extends in the Y direction. The portion 91d includes a side 91h and a side 91i that are arranged in the Y direction. Each of the side 91h and the side 91i extends in the X direction. The side 91h connects end portions of each of the side 91f and the side 91g on the Y1 side to each other. The side 91i connects end portions of each of the side 91f and the side 91g on the Y2 side to each other.

The elastic portion 91b includes a plurality of the portions 91e. Each of the portions 91e extends in the X direction. Each of the portions 91e connects the side 91f and the side 91g. The portions 91e are arranged in the Y direction at intervals from each other, between the side 91h and the side 91i.

As illustrated in FIG. 4, each of the elastic portions 91a is disposed in a space between adjacent portions 91e that are arrayed in the Y direction. Also, each of the elastic portions 91a is disposed in a space between the side 91f and the side 91g. The elastic portion 91b and each of the elastic portions 91a may be provided separately (may be separate bodies). In this case, each of the elastic portions 91a may be joined (e.g., bonded with an adhesive or the like) to at least one of the portions 91e adjacent in the Y direction and the side 91f (side 91g) adjacent in the X direction.

As described above, in the present embodiment, the elastic portions 91a are provided at the position P1 that does not overlap the gas channel 88 in the Z direction, and the elastic portion 91b is provided at the position P2 that overlaps with the gas channel 88 in the Z direction. Thus, the gas channel 88 can be suppressed from being pressed by the relatively hard (high rigidity) elastic portion 91a of the elastic member 91. As a result, the gas channel 88 can be suppressed from being crushed.

Also, even when the gas channel 88 is crushed, the elastic portion 91b that is relatively soft (with low rigidity) can be expanded by the gas. As a result, obstruction of the gas flow can be suppressed.

### Modifications

In the above embodiment, an example has been described in which the restraint device 100 is used during the manufacturing process of the power storage module, but the present disclosure is not limited to this. For example, a power storage unit (power storage device) in a state in which power storage modules are restrained by a restraint device may be installed in electronic equipment such as an electrified vehicle or the like.

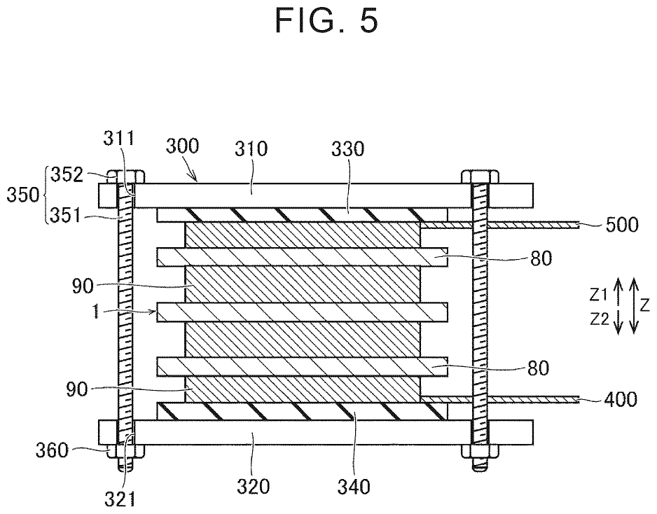

For example, a restraint device 300 that is illustrated in FIG. 5 includes end plates 310 and 320, insulating films 330 and 340, bolts 350, and nuts 360. The insulating film 330 is disposed on a lower face of the end plate 310. The insulating film 340 is disposed on an upper face of the end plate 320. Note that for simplification, in FIG. 5, the end plate 310 and the end plate 320 are each represented by an open block. Also, each of the end plate 310 and the end plate 320 is an example of “pressing member” in the present disclosure.

The stack 1 is disposed between the insulating film 330 and the insulating film 340. Interposition modules 90 are disposed on a lower face of the insulating film 330 and on an upper face of the insulating film 340. A cathode terminal 400 is connected to the interposition module 90 that is disposed on the upper face of the insulating film 340. An anode terminal 500 is connected to the interposition module 90 that is disposed on the lower face of the insulating film 330. Note that each of the cathode terminal 400 and the anode terminal 500 is connected to a current collector plate, omitted from illustration, included in the interposition module 90.

The bolts 350 and the nuts 360 link the end plate 310 and the end plate 320 together. Each of the bolts 350 includes a shaft portion 351 and a head 352. The head 352 is provided at an upper end portion of the shaft portion 351. The head 352 is disposed on an upper face of the end plate 310. The shaft portion 351 has a groove formed thereon that corresponds to the nut 360.

The shaft portion 351 of the bolt 350 passes through a through hole 311 that is formed in the end plate 310 and a through hole 321 that is formed in the end plate 320. The nut 360 is attached to a lower end portion of the shaft portion 351 and is disposed on a lower face of the end plate 320. Thus, the bolt 350 and the nut 360 apply a restraint load to the stack 1 in the Z direction.

In the above embodiment, an example has been described in which each of the elastic portions 91a is provided separately from the elastic portion 91b, but the present disclosure is not limited to this. Each of the elastic portions 91a may be integrally formed with the elastic portion 91b. That is to say, the elastic member 91 may be a single member including a plurality of the elastic portions 91a and the elastic portion 91b. In other words, the elastic portions 91a and the elastic portion 91b may be formed continuously.

In the above embodiment, the elastic portions 91a and the elastic portion 91b are made of the same material, but the present disclosure is not limited to this. The elastic portion 91b (second elastic portion) may be made of a material that is softer (has lower rigidity) than that of the elastic portions 91a (first elastic portion).

In the above embodiment, an example has been described in which the elastic member 91 is a foaming member, but the present disclosure is not limited to this. The elastic member may be made of a material that is different from the foaming member. For example, the elastic member may be made of silicone rubber or the like. In this case, the first elastic portion, and the second elastic portion that is softer than the first elastic portion, may be formed by adjusting the amount and type of additive that is added to the silicone rubber, or the like.

In the above embodiment, an example has been described in which the elastic portion 91b includes the portion 91d and the portions 91e, but the present disclosure is not limited to this. The elastic portion 91b may include just one of the portion 91d and the portions 91e.

The embodiment that is disclosed herein should be considered to be exemplary in all respects and not restrictive. The scope of the present disclosure is indicated by the claims rather than the description of the embodiment described above, and it is intended that all changes within the meaning and scope equivalent to the claims are included.

What is claimed is:

1. A restraint device for restraining a power storage module, the restraint device comprising:
an elastic member that is stacked with the power storage module in a stacking direction, in a state in which the power storage module is restrained; and
a pressing member that presses the elastic member toward the power storage module, wherein
the power storage module includes an electrode plate,
the electrode plate includes
a current collector, and
an electrode layer that is stacked with the current collector in the stacking direction,
a gas channel is fashioned in the electrode layer,
the elastic member includes
a first elastic portion, and
a second elastic portion that is softer than the first elastic portion,
the first elastic portion is provided at a first position not overlapping the gas channel in the stacking direction, and
the second elastic portion is provided at a second position overlapping the gas channel in the stacking direction.

2. The restraint device according to claim 1, wherein
the electrode layer includes an adjacent portion that is adjacent to the gas channel when viewing the electrode plate from a position away from the electrode plate in the stacking direction, and
the second elastic portion extends from the second position to a position of overlapping the adjacent portion in the stacking direction.

3. The restraint device according to claim 1, wherein
the gas channel includes
a first gas channel extending along an outer peripheral edge portion of the electrode plate, and
a second gas channel that is fashioned on an inner side from the outer peripheral edge portion of the electrode plate, and
when viewing the electrode plate from a position away from the electrode plate in the stacking direction, the second elastic portion includes
a first portion extending along the first gas channel, and
a second portion extending along the second gas channel.

4. The restraint device according to claim 1, wherein
the elastic member is a foaming member containing a foaming agent, and
a density of the foaming agent in the second elastic portion is higher than a density of the foaming agent in the first elastic portion.
